(19) United States
(12) Patent Application Publication
(10) Pub. No.: US 2015/0068982 A1
(43) Pub. Date: Mar. 12, 2015

(54) WATER TREATMENT PROCESS AND WATER TREATMENT SYSTEM

(71) Applicant: MITSUBISHI HEAVYH INDUSTRIES, LTD., Tokyo (JP)

(72) Inventors: Ryuji Yoshiyama, Tokyo (JP); Susumu Okino, Tokyo (JP); Jun Satou, Tokyo (JP); Hideaki Sakurai, Tokyo (JP); Hideo Suzuki, Tokyo (JP); Hiroshi Nakashoji, Tokyo (JP); Shigeru Yoshioka, Tokyo (JP); Nobuyuki Ukai, Tokyo (JP); Masayuki Eda, Tokyo (JP)

(73) Assignee: MITSUBISHI HEAVY INDUSTRIES, LTD., Tokyo (JP)

(21) Appl. No.: 14/363,992

(22) PCT Filed: Apr. 25, 2013
(86) PCT No.: PCT/JP2013/062283

§ 371 Date: Jun. 9, 2014

(51) Int. Cl. C02F 9/00; C02F 5/02; C02F 1/66

(52) U.S. Cl. CPC C02F 9/00; C02F 1/66; C02F 5/02; C02F 2101/10
USPC 210/711; 210/714; 210/713

(57) ABSTRACT

A water treatment method and a water treatment system that are capable of treating water containing salts to allow recovery of treated water at a high ion removal rate and a high water recovery rate, and allow recovery of high quality gypsum are provided. In the water treatment system, the water to be treated containing Ca²⁺ and SO₄²⁻ is separated into concentrated water in which Ca²⁺ and SO₄²⁻ are concentrated and treated water containing CO₂ in a first demineralizer so that the treated water is recovered. The concentrated water in the first demineralizer is adjusted to a pH at which calcium carbonate can be dissolved and the scale inhibition function of a scale inhibitor is reduced, and then is delivered to a crystallizing tank. In the crystallizing tank, gypsum is crystallized from the concentrated water in the first demineralizer. The gypsum is separated and recovered in a separating section.

### TECHNICAL FIELD

The present invention relates to a water treatment process and a water treatment system which allow regeneration of water to be treated containing Ca ions (Ca²⁺), sulfate ions (SO₄²⁻) and carbonate ions.

### BACKGROUND ART

Mine waste water contains pyrite (FeS₂), and this pyrite is oxidized to produce SO₄²⁻. Inexpensive Ca(OH)₂ is used to neutralize mine waste water. Therefore, mine waste water abundantly contains Ca²⁺ and SO₄²⁻.

Brine, sewage water and industrial waste water are known to also abundantly contain Ca²⁺ and SO₄²⁻. In a cooling tower, heat exchange is carried out between high-temperature exhaust gas discharged from a boiler and the like and cooling water. This heat exchange converts part of the cooling water into steam, so that ions in the cooling water are concentrated. Thus, the cooling water discharged from the cooling tower (blow-down water) is brought into a state where the concentrations of ions such as Ca²⁺ and SO₄²⁻ are high.

Water containing large amounts of ions is subjected to demineralization treatment, and then released into an environment. Lime soda method is indicated as a method for removing Ca²⁺. The lime soda method involves adding sodium carbonate to water to be treated so that Ca²⁺ in the water to be treated is precipitated as calcium carbonate and removed.

Patent Literature 1 discloses a water treatment process and a water treatment device for treating raw water containing Ca²⁺ and SO₄⁻. In Patent Literature 1, raw water containing Ca²⁺ and SO₄²⁻ as divalent ions is allowed to pass through a nanofiltration membrane device, thereby separating between Ca²⁺ and SO₄²⁻ and monovalent ions (such as Na⁺, Cl−). The treated water in the nanofiltration membrane device contains monovalent ions, but is allowed to pass through a reverse osmosis membrane device at the latter stage, thereby obtaining the treated water from which monovalent ions have been removed. The construction for circulating part of concentrated water in the nanofiltration membrane device to the nanofiltration membrane device involves concentrating divalent ions to the saturation concentrations or higher, and then adding seed crystals in the concentrated liquid to crystallize Ca²⁺ and SO₄²⁻ as gypsum, thereby removing Ca²⁺ and SO₄²⁻.

### CITATION LIST

### Patent Literature

{PTL 1} Japanese Unexamined Patent Application, Publication No. 2011-200788

### SUMMARY OF INVENTION

### Technical Problem

The lime soda method is high in treatment cost as requiring the addition of sodium carbonate for treatment.

For example, when water after removal of Ca²⁺ by the lime soda method was combined with a demineralizer such as a reverse osmosis membrane device to further remove ion contents, Na⁺ in treated water increased, and SO₄²⁻ could not be removed so that SO₄²⁻ remained, thereby disadvantageously resulting in high osmotic pressure. There was also the problem of reduction in water recovery rate.

In the device of Patent Literature 1, because of concentration of Ca²⁺ and SO₄²⁻, there is a fear that gypsum may be deposited as a scale in the nanofiltration membrane device, thereby causing deterioration in treating ability.

Also, in the treatment of Patent Literature 1, the water to be treated contains CO₃²⁻ derived from air and the like. While crystallization causes coprecipitation of calcium carbonate and gypsum, calcium carbonate and gypsum are not separated from each other in the technique of Patent Literature 1. Hence, the purity of the gypsum recovered by the device of Patent Literature 1 is low. In order to utilize the recovered gypsum for other applications, the gypsum must be purified, leading to increase in cost. Therefore, the utilization of the gypsum recovered from mine waste water and the like to other applications has been inhibited.

An object of the present invention is to provide a water treatment process and a water treatment system that are capable of treating water containing salts to allow recovery of treated water at a high ion removal rate and a high water recovery rate, along with to allow recovery of high-quality gypsum.

### Solution to Problem

An aspect of the present invention is a water treatment process including: a scale inhibitor supplying step of supplying a scale inhibitor to water to be treated containing Ca ions, SO₄ ions and carbonate ions; an upstream side separating step of separating the water to be treated into concentrated water in which the Ca ions and the SO₄ ions are concentrated, in a first demineralizer, and recovering the treated water; a first pH adjusting step of adjusting the concentrated water in the first demineralizer to a pH at which calcium carbonate is soluble and a scale inhibiting function of the scale inhibitor is reduced so that gypsum is deposited from the concentrated water in the first demineralizer; a crystallizing step of crystallizing crystals of the gypsum from the concentrated water in the first demineralizer having the adjusted pH; and a recovering step of separating and recovering the crystals from the concentrated water in the first demineralizer.

Another aspect of the present invention is a water treatment system including: a scale inhibitor supplying section which supplies a scale inhibitor to water to be treated containing Ca ions, SO₄ ions and carbonate ions; a first demineralizer which is installed on a downstream side of the scale inhibitor supplying section, and separates the water to be treated into treated water containing the CO₂ and concentrated water in which the Ca ions and the SO₄ ions are concentrated; a first pH adjusting section which is installed on a downstream side of the first demineralizer, and supplies a pH adjuster to the concentrated water in the first demineralizer to adjust the concentrated water in the first demineralizer to a pH at which calcium carbonate is soluble and a scale inhibiting function of the scale inhibitor is reduced so that gypsum is deposited; a crystallizing tank which crystallizes the gypsum from the concentrated water in the first demineralizer having the adjusted pH; and a separating section which separates the crystallized gypsum and the concentrated water in the first demineralizer from each other.

In the present invention, the water to be treated is separated into concentrated water containing Ca²⁺ and SO₄²⁻ and treated water by a first demineralizer. The concentrated water in the first demineralizer is adjusted to a pH at which calcium carbonate is soluble and the function of the scale inhibitor is reduced. The sentence that “calcium carbonate is soluble” herein means that calcium carbonate is deposited in a small amount in water, which does not affect the purity of gypsum.

In general, calcium carbonate is known to be dissolved in an acidic state. Thus, the pH of the concentrated water is adjusted into an acidic region. Therefore, the deposition of calcium carbonate from the concentrated water is significantly suppressed.

The concentrated water adjusted to the above-described pH is delivered to a crystallizing tank. Even when a scale inhibitor is present in the concentrated water, the function thereof is reduced. Therefore, when the concentration of gypsum exceeds the saturation concentration, crystals of the gypsum are deposited.

The present invention allows treatment of water to be treated containing Ca ions, SO₄ ions and carbonate ions at a high water recovery rate and also recovery of high-purity gypsum in the process of water treatment.

In the water treatment process according to the above aspect, it is preferable that the water treatment process further includes a second pH adjusting step of adjusting the water to be treated to a pH at which the calcium carbonate is soluble and the scale inhibitor is capable of suppressing the deposition of a scale containing Ca, on an upstream side of the first demineralizer.

In the water treatment system according to the above aspect, it is preferable that the water treatment system further includes a second pH adjusting section which is installed on an upstream side of the first demineralizer, and supplies a pH adjuster to the water to be treated to adjust the water to be treated to a pH at which the calcium carbonate is soluble and the scale inhibitor is capable of suppressing the deposition of a scale containing Ca.

When the pH of the water to be treated is adjusted on an upstream side of the first demineralizer in the above-described manner, carbonates in the water to be treated would be decomposed into HCO₃⁻ and CO₂ and then demineralized by the first demineralizer. The concentration of calcium carbonate in the concentrated water in the first demineralizer would be reduced, and, further, the deposition of calcium carbonate in the first demineralizer is suppressed by the effect of the scale inhibitor. Also, the deposition of the gypsum in the first demineralizer is suppressed.

In the water treatment process according to the above aspect, it is preferable that seed crystals of the gypsum are supplied to the concentrated water in the first demineralizer in the crystallizing step.

In the water treatment system according to the above aspect, it is preferable that the water treatment system further includes a seed crystal supplying section which supplies seed crystals of the gypsum to the crystallizing tank.

Upon addition of seed crystals, gypsum grows around the seed crystals as cores, thereby allowing deposition of large gypsum. The water content of the gypsum is reduced, so that the salts contained in water can be reduced, thereby obtaining high-purity gypsum. Also, a classifier and a dehydrator in a separating section can be reduced in size.

In the water treatment process according to the above aspect, the separated and recovered gypsum may be supplied, as the seed crystals, into the concentrated water in the first demineralizer in the crystallizing step.

In the water treatment system according to the above aspect, the water treatment system may further include a circulating section which supplies the gypsum separated and recovered in the separating section, as the seed crystals, to the seed crystal supplying section.

The above-described construction can suppress the operation cost and can also recover high-quality gypsum at a low cost.

In the water treatment process according to the above aspect, it is preferable that gypsum having a predetermined size, in the gypsum deposited in the crystallizing step, is separated and recovered in the recovering step.

In the water treatment system according to the above aspect, it is preferable that the separating section includes a classifier which recovers gypsum having a predetermined size in the gypsum deposited in the crystallizing tank.

The larger the particle diameter of gypsum is, the more the water content thereof is reduced. By crystallization using seed crystals, gypsum having a predetermined particle diameter or more is easily crystallized. Therefore, the water content becomes lower, thereby making it possible to reduce the salts contained in water of the gypsum. Thus, high-purity gypsum can be recovered.

In the water treatment process according to the above aspect, it is preferable that the water treatment process includes a downstream side separating step of separating the concentrated water in the first demineralizer after the crystallizing step into concentrated water and treated water in a second demineralizer, and recovering the treated water. In this case, it is preferable that, on a downstream side of the concentrated water in the second demineralizer, water is evaporated from the concentrated water in the second demineralizer so that a solid is recovered.

In the water treatment system according to the above aspect, it is preferable that the water treatment system further includes a second demineralizer which is installed on a downstream side of the separating section and separates the concentrated water in the first demineralizer into concentrated water and treated water. In this case, it is preferable that the water treatment system further includes an evaporator which evaporates water from the concentrated water in the second demineralizer to recover a solid, at a downstream on a side of the concentrated water in the second demineralizer.

By providing a second demineralizer, the water recovery rate can further be improved. In the invention, since the concentrations of ions in the water to be treated are greatly reduced by the crystallizing section, the amount of salts flowing into the second demineralizer can be reduced. Therefore, the motive power of the second demineralizer can be reduced.

### Advantageous Effects of Invention

According to the present invention, it is possible to add a scale inhibitor, to adjust the pH so that calcium carbonate is soluble, and to develop the function of the scale inhibitor, thereby reproducing the water to be treated at a high water recovery rate while preventing the generation of scales such as calcium carbonate and gypsum in a demineralizer.

The present invention allows pH adjustment of concentrated water containing Ca²⁺ and SO₄²⁻ to reduce the function of a scale inhibitor to induce a state where gypsum is easily deposited, thereby separating and recovering high-purity gypsum in crystallization. The recovered gypsum can be recycled.

Also, the amount of salts flowing into a second demineralizer can be reduced in order to remove Ca²⁺ and SO₄²⁻ in the water to be treated in a crystallizing section.

### BRIEF DESCRIPTION OF DRAWINGS

FIG. 1 is a schematic view of a water treatment system according to a first embodiment.

FIG. 2 is a graph for explaining the pH dependency of Stiff & Davis Stability Index of calcium carbonate.

FIG. 3 shows simulation results of changes in amount of deposited calcium carbonate depending on changes in pH.

FIG. 4 shows results of a gypsum deposition experiment carried out by using simulated water in which gypsum is in a supersaturated state and by changing the pH of the simulated water.

FIG. 5 shows results of a gypsum deposition experiment carried out by using simulated water in which gypsum is in a supersaturated state and by changing the concentration of seed crystals.

FIG. 6 is a microscopic photograph of gypsum crystallized under Condition 5.

FIG. 7 is a microscopic photograph of gypsum crystallized under Condition 3.

FIG. 8 is a schematic view of a water treatment system according to a second embodiment.

FIG. 9 is a schematic view of a water treatment system according to a third embodiment.

### DESCRIPTION OF EMBODIMENTS

Water to be treated in the present invention (water to be treated) contains Ca²⁺ and SO₄²⁻, and has such a water quality that the concentration of gypsum exceeds the saturation solubility or that the concentration of gypsum exceeds the saturation solubility by water treatment. For example, the water to be treated includes mine waste water, brine, sewage water, industrial waste water and blow-down water of a cooling tower.

The water to be treated contains carbonate ions (CO₃²⁻) derived from air and the like.

### First Embodiment

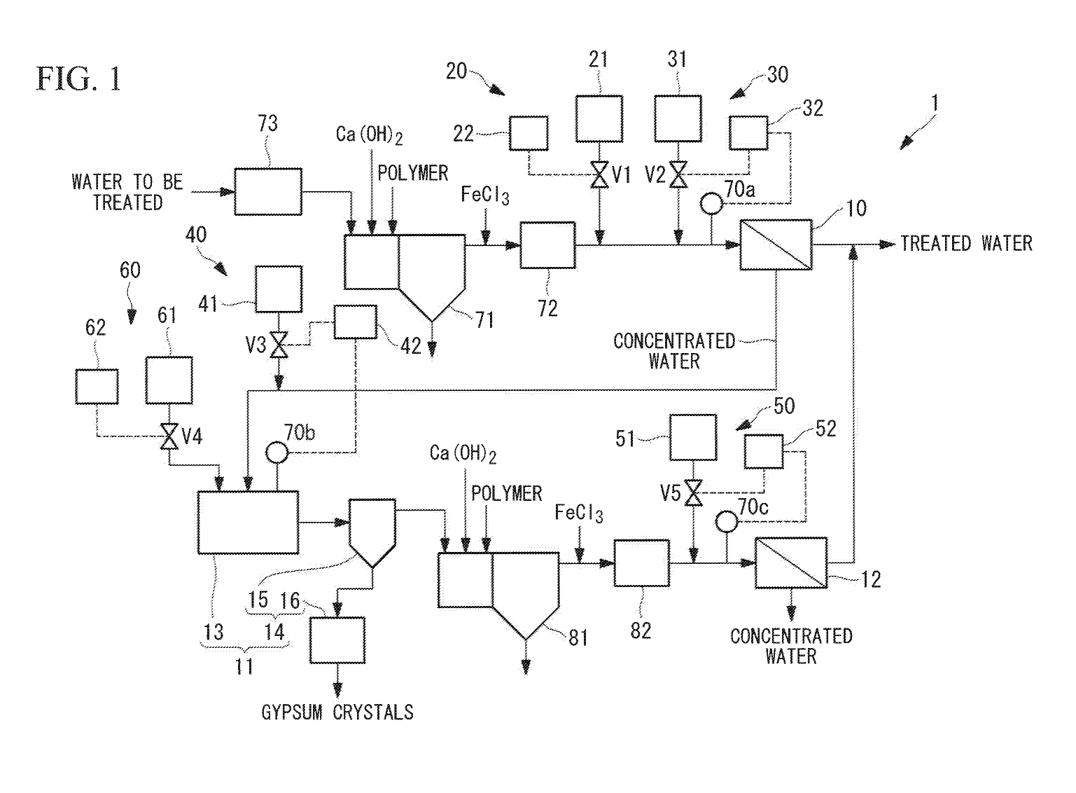

FIG. 1 is a schematic view of a water treatment system according to a first embodiment of the present invention. A water treatment system 1 according to the first embodiment includes a crystallizing section 11. A first demineralizer 10 is installed on an upstream side of the crystallizing section 11, and a second demineralizer 12 is installed on a downstream side thereof. In the water treatment system 1 according to this embodiment, the concentration side of the first demineralizer 10 and a crystallizing tank 13 are connected to each other.

While FIG. 1 shows only one first demineralizer 10 and only one second demineralizer 12, such a construction may be employed that a plurality of the respective demineralizers are coupled in parallel or series in a direction in which water to be treated is distributed.

In FIG. 1, the first demineralizer 10 and second demineralizer 12 are reverse osmosis membrane devices, but, for example, an electrodialyzer (ED), an electro dialysis reversal device (EDR), an electro de-ionization device (EDI), an ion exchange resin device, an capacitive de-ionization device (CDI), a nano filter (NF) and an evaporator are also applicable.

The crystallizing section 11 is composed of a crystallizing tank 13 and a separating section 14 in order from the upstream side of the water to be treated. In FIG. 1, the separating section 14 is composed of a classifier 15 and a dehydrator 16. The classifier 15 is, for example, a liquid cyclone. The dehydrator 16 is, for example, a belt filter 16.

In the meantime, the classifier can be omitted as a modified example of this embodiment. In this case, the water treatment system is constructed in such a manner that the bottom part of the crystallizing tank 13 and the dehydrator 16 are directly connected to each other.

A scale inhibitor supplying section 20 is composed of a tank 21, a valve V1 and a controlling section 22. The controlling section 22 is connected to the valve V1. Within the tank 21, a scale inhibitor is stored. The scale inhibitor has the function to suppress the production of crystal cores in the water to be treated and also to be adsorbed on the surfaces of the crystal cores (for example, seed crystals and small-diameter scales deposited over the saturation concentration) contained in the water to be treated to suppress crystal growth. Also, the scale inhibitor also has the function to disperse particles in the water to be treated, such as deposited crystals (prevent aggregation). The scale inhibitor is a phosphonic acid-based scale inhibitor, a polycarboxylic acid-based scale inhibitor, and a mixture thereof etc. FLOCON260 (trade name, manufactured by BWA) is indicated as an example of the scale inhibitor.

The scale inhibitor supplying section 20 and a second pH adjusting section 30 are connected to a flow passage on an upstream side of the first demineralizer 10. A first pH adjusting section 40 is connected to a flow passage between the first demineralizer 10 and the crystallizing section 11. The first pH adjusting section 40 may be constructed so as to be connected to the crystallizing tank 13.

In the water treatment system 1 of this embodiment, a precipitating section 71 and a filtration device 72 may be installed at an upstream of the scale inhibitor supplying section 20 and the second pH adjusting section 30. For example, when mine waste water is treated, an oxidizing section 73 may be installed at an upstream of the precipitating section 71 as shown in FIG. 1.

A precipitating section 81 and a filtration device 82 are installed between the separating section 14 and the second demineralizer 12. The precipitating section 81 and filtration device 82 have the same constructions as the precipitating section 71 and filtration device 72, respectively. A third pH adjusting section 50 is installed in a flow passage between the filtration device 82 and the second demineralizer 12.

pH meters 70a to 70c are installed at the inlet of the first demineralizer 10, crystallizing tank 13 and inlet of the second demineralizer 12.

The second pH adjusting section 30 is composed of a tank 31, a valve V2 and a controlling section 32, and an acid is stored as a pH adjuster within the tank 31. The controlling section 32 is connected to the valve V2 and pH meter 70a.

The first pH adjusting section 40 is composed of a tank 41, a valve V3 and a controlling section 42, and an acid is stored as a pH adjuster within the tank 41. The controlling section 42 is connected to the valve V3 and pH meter 70b.

As a modified example of this embodiment, the second pH adjusting section can be omitted, and the first pH adjusting section 40 alone may be provided between the first demineralizer 10 and the crystallizing section 11.

Another modified example of this embodiment may be such a construction example that the second pH adjusting section is omitted, and that the first pH adjusting section 40 is installed in a flow passage on an upstream side of the first demineralizer 10 (position where the second pH adjusting section is provided in FIG. 1). In this case, the controlling section 42 of the first pH adjusting section 40 is connected to pH meters 70a, 70b. In the meantime, in this modified example, no pH adjusting section is provided between the first demineralizer 10 and the crystallizing section 11.

The kind of the acid to be stored as the pH adjuster in the second pH adjusting section 30 and first pH adjusting section 40 is not particularly limited, but is preferably sulfuric acid. This is because SO₄²⁻ derived from sulfuric acid is removed in the latter-stage crystallizing section 11 to suppress the increase in motive power in the second demineralizer 12.

The third pH adjusting section 50 is composed of a tank 51, a valve V5 and a controlling section 52, and an acid is stored as a pH adjuster within the tank. The kind of the acid to be stored in the tank 51 is not particularly limited. The controlling section 52 is connected to the valve V5 and pH meter 70c.

A seed crystal supplying section 60 is connected to the crystallizing tank 13. The seed crystal supplying section 60 has a seed crystal tank 61, a valve V4 and a controlling section 62. The controlling section 62 is connected to the valve V4. The seed crystal tank 61 stores gypsum particles as seed crystals therein. In the meantime, when no seed crystal is charged, the seed crystal supplying section 60 can be omitted.

A process for treating water to be treated using the water treatment system 1 of the first embodiment will be explained below.

### <Pretreatment>

When water to be treated is mine waste water, air is introduced into the water to be treated in the oxidizing section 73. By this step, pyrite (FeS₂) in the water to be treated is oxidized to produce Fe ions (Fe³⁺) and SO₄²⁻ ions.

When the water to be treated is industrial waste water, the step of removing, for example, an oil content and floating particles and the step of removing an organic matter by biological treatment or chemical oxidization treatment are carried out in place of the oxidization treatment in the oxidizing section 73.

Metal ions in the water to be treated are roughly removed as metal hydroxides in the precipitating section 71 and filtration device 72.

Mine waste water shows strong acidity. Ca(OH)₂ and anionic polymers (manufactured by MITSUBISHI HEAVY INDUSTRIES MECHATRONICS SYSTEMS, LTD.; Hishifloc H305) are charged into the water to be treated in the precipitating section 71, and the pH within the precipitating section 71 is managed to be alkaline (8.5 to 11).

In this pH region, the solubility of calcium carbonate and metal hydroxides is low. When the calcium carbonate and metal hydroxides become supersaturated, the calcium carbonate and metal hydroxides are deposited and precipitated at the bottom part of the precipitating section 71.

The solubility of metal hydroxides depends on pH. The more acidic the pH is, the higher the solubility of metal ions in water becomes. In the above-described pH region, the metals contained in the water to be treated are precipitated as metal hydroxides at the bottom part of the precipitating section 71 because of low solubility of many metal hydroxides.

The water to be treated which is a supernatant within the precipitating section 71 is discharged from the precipitating section 71. FeCl₃ is added to the discharged water to be treated so that solid contents such as calcium carbonate, metal hydroxides and the like in the water to be treated are agglomerated with Fe(OH)₃.

The water to be treated is delivered to the filtration device 72. The solid contents having agglomerated Fe(OH)₃ are removed by the filtration device 72.

Fe is easily deposited as a hydroxide in an acidic state. When the water to be treated containing a large amount of Fe ions is allowed to flow into a downstream of the first demineralizer 10, a scale containing Fe is generated within the first demineralizer 10, and also an iron hydroxide or the like is precipitated in the crystallizing tank 13. In this embodiment, the treatment conditions in the precipitating section 71, amount of FeCl₃ to be added and the like are appropriately set so that the concentration of Fe ions in the water to be treated after pretreatment and before flowing into the first demineralizer 10 is 0.05 ppm, in consideration of the prevention of scale generation within the first demineralizer 10.

In the meantime, the above-described pretreatment can be omitted depending on the water quality of the water to be treated.

### <Scale Inhibitor Supplying Step>

The controlling section 22 of the scale inhibitor supplying section 20 opens the valve V1 to supply a predetermined amount of scale inhibitor from the tank 21 into the water to be treated. The controlling section 22 adjusts the opening degree of the valve V1 so that the concentration of the scale inhibitor is a predetermined value set according to the characteristics of the water to be treated.

### <Second pH Adjusting Step>

The controlling section 32 of the second pH adjusting section 30 manages the pH of the water to be treated at the inlet of the first demineralizer 10 to such a value that the deposition of scales (gypsum and calcium carbonate) containing Ca is suppressed by the scale inhibitor.

The pH meter 70a measures the pH of the water to be treated at the inlet of the first demineralizer 10. The controlling section 32 adjusts the opening degree of the valve V2 so that the measurement value at the pH meter 70a is a predetermined pH management value.

In a modified example wherein no second pH adjusting section is provided, the second pH adjusting step is omitted.

### <Upstream Side Separating Step>

In the first demineralizer 10, the water to be treated whose pH has been adjusted is treated. The water having passed through the reverse osmosis membrane of the first demineralizer 10 is recovered as treated water. The ions and scale inhibitor contained in the water to be treated cannot permeate the reverse osmosis membrane. Thus, concentrated water having a high ion concentration is present on a non-permeated side of the reverse osmosis membrane. The concentrated water in the first demineralizer 10 is delivered toward the crystallizing tank 13.

For example, also when other demineralizers such as an capacitive de-ionization device are used, the water to be treated is separated into treated water and concentrated water having a high ion concentration.

### <First pH Adjusting Step>

The controlling section 42 manages the pH of the concentrated water in the first demineralizer within the crystallizing tank 13 to such a value that the function of the scale inhibitor is reduced so that gypsum can be deposited in the concentrated water.

The pH meter 70b measures the pH of the concentrated water in the first demineralizer within the crystallizing tank 13. The controlling section 42 adjusts the opening degree of the valve V3 so that the measurement value at the pH meter 70b is a predetermined pH management value.

### <Crystallizing Step>

The concentrated water whose pH has been adjusted by the first pH adjusting step is stored in the crystallizing tank 13. When the seed crystal supplying section 60 is installed, the seed crystal supplying section 60 adds seed crystals to the concentrated water within the crystallizing tank 13.

The function of the scale inhibitor is reduced by the first pH adjusting step. Therefore, the supersaturated gypsum is crystallized. When seed crystals are charged in the crystallizing step, crystals of gypsum grow around the seed crystals as cores.

The setting of the conditions for the first pH adjusting step, second pH adjusting step and crystallizing step will be explained below.

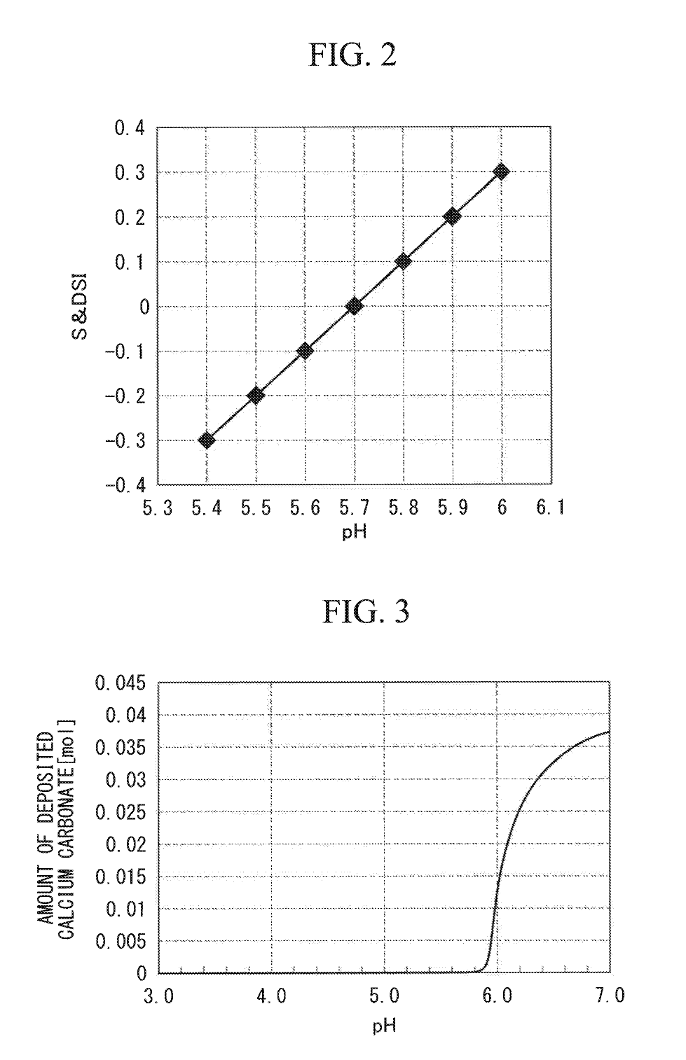

FIG. 2 is a graph for explaining the pH dependency of the solubility of calcium carbonate, and shows an example of trial calculation of Stiff & Davis Stability Index (S & DSI) in the concentrated water in a reverse osmosis membrane device as a demineralizer when the characteristics of mine waste water are defined as raw water characteristics. In this figure, the pH and S & DSI are plotted on the abscissa and ordinate, respectively. In the meantime, the reverse osmosis membrane device is indicated as an example in FIG. 2, but other demineralizers as indicated above give similar results.

According to FIG. 2, it is seen that, within a pH region of 5.7 or less, S & DSI is 0 or more, and that calcium carbonate tends to be dissolved. Namely, when the pH of the water to be treated or concentrated water is adjusted to 5.7 or less, calcium carbonate becomes in a dissolved state, thereby making it possible to prevent the deposition of calcium carbonate. In the consideration of the variation in Ca²⁺ concentration of the water to be treated, the pH is preferably 5.5 or less.

FIG. 3 shows simulation results of changes in amount of deposited calcium carbonate depending on changes in pH using simulation software manufactured by OLI. In this figure, the pH and amount of deposited calcium carbonate (mol) are plotted on the abscissa and ordinate, respectively. According to FIG. 3, it can be understood that calcium carbonate starts to be deposited at a pH between 5.8 and 5.9, and that the amount of deposited calcium carbonate drastically increases at within a pH region between 6.0 and 6.5.

FIGS. 2 and 3 show simulation results obtained using mutually different water sources. Therefore, since the results are affected not only by the calcium ion concentration, but also the carbonate ion component as the conditions for deposition of calcium carbonate in water, a pH deviation occurs. In an actual solution system, when its pH is 6.5 or less, preferably 6.0 or less, more preferably 5.5 or less, the solubility of calcium carbonate is high so that calcium carbonate is sufficiently soluble in water.

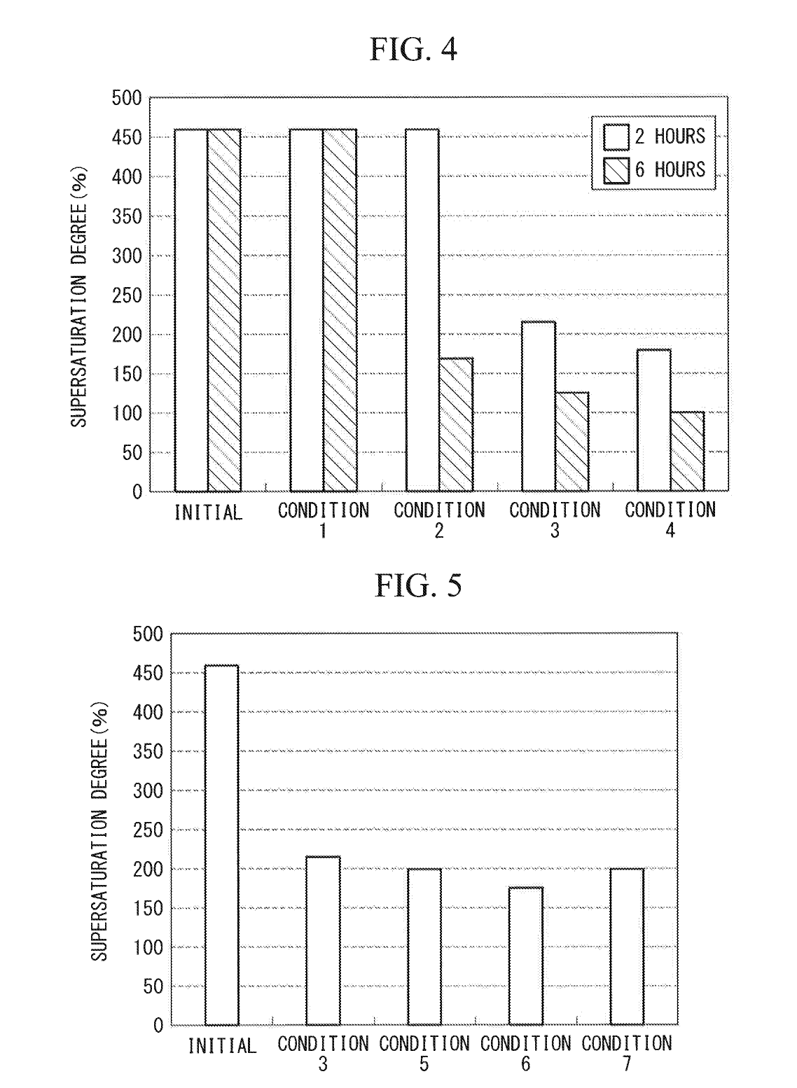

FIG. 4 shows results of a gypsum deposition experiment carried out by changing the pH of simulated water in which gypsum was in a supersaturated state (containing Ca²⁺, SO₄²⁻, Na⁺ and Cl⁻) when a scale inhibitor (FLOCON260) was added to the simulated water. The experimental conditions are as follows:

Gypsum supersaturation degree of simulated water (25° C.): 460%:

Amount of added scale inhibitor: 2.1 mg/L;

pH: 6.5 (Condition 1), 5.5 (Condition 2), 4.0 (Condition 3), 3.0 (Condition 4); and

Amount of added seed crystals: 0 g/L.

FIG. 4 shows results of measuring the Ca concentration in the simulated water treated under the respective conditions using an atomic absorption spectrometer (manufactured by Shimadzu Corporation; AA-7000) after a lapse of 2 hours and 6 hours immediately after the pH adjustment to calculate the supersaturation degree. In this figure, the supersaturation degree (%) is plotted on the ordinate.

Under Condition 1 (pH 6.5), the supersaturation degree is 460%, and is unchanged from the initial supersaturation degree even after a lapse of 6 hours. Under Condition 1, the scale inhibitor develops its function so that the deposition of gypsum is suppressed.

On the other hand, the supersaturation degree is reduced under Conditions 2 to 4. Namely, it could be confirmed that, when the pH was reduced, the function of the scale inhibitor was reduced, resulting in deposition of gypsum, even though no seed crystal was charged. Also, the result was obtained that the lower the pH was, the higher the deposition speed was.

FIG. 5 shows results of a gypsum deposition experiment carried out by changing the amount of added seed crystals when a scale inhibitor (FLOCON260) was added to the simulated water. The same experimental conditions as those in FIG. 4 were employed except the pH was 4.0 and CaSO₄.2H₂O was added as seed crystals in the following amounts:

Amount of added seed crystals: 0 g/L (Condition 3); 3 g/L (Conditions 5, 7), 6 g/L (Condition 6).

Under Conditions 5, 6, seed crystals and sulfuric acid as a pH adjuster were added to the simulated water to which the scale inhibitor was added. Under Condition 7, seed crystals preliminarily immersed in the above-described scale inhibitor were added to the simulated water to which the scale inhibitor was added, and sulfuric acid was added for pH adjustment.

After a lapse of 2 hours immediately after the pH adjustment, the concentration of Ca in the simulated water treated under the respective conditions was measured by a similar method as that in FIG. 4. In FIG. 5, the supersaturation degree (%) is plotted on the ordinate.

The results shown in FIG. 5 indicate that the supersaturation degree was 215% under Condition 3 involving addition of no seed crystal, but was reduced to 199% (Condition 5) and 176% (Condition 6) as the seed crystal concentration increased, and that the gypsum deposition speed increased.

Conditions 5 and 7 are the same test conditions except that seed crystals not immersed in the scale inhibitor and seed crystals immersed in the scale inhibitor were employed.

It could be confirmed that, even under Condition 7 in which the scale inhibitor was preliminarily attached to seed crystals, the supersaturation degree was 199%, and that an equivalent level of gypsum to that under Condition 5 was deposited. Namely, the results obtained under Conditions 5, 7 indicate that the function of the scale inhibitor is reduced by reducing the pH to 4.0.

From the results in FIGS. 2 to 5, when the second pH adjusting step is carried out, the water to be treated is adjusted to a pH at which a salt containing Ca (gypsum, calcium carbonate) is soluble and the function of the scale inhibitor is developed (in the results in FIGS. 2 to 5, the pH is 6.5 or less, preferably 6.0 or less, more preferably 5.5 or less). Carbonates in the water to be treated are in the following equilibrium state depending on the pH of the water to be treated. When the pH is low, i.e., 6.5 or less, carbonates are present mainly in the states of HCO₃⁻ and CO₂ in the water to be treated.

{Chemical Formula 1}

CO₂⇄H₂CO₃⇄HCO₃⁻+H⁺⇄CO₃²⁻+2H⁺ (1)

Therefore, when the water to be treated is adjusted to the above-described pH, the carbonates in the water to be treated are present as HCO₃⁻ and CO₂, and the treated water containing CO₂ is recovered in the first demineralizer 10. The concentrated water in the first demineralizer 10 has a reduced carbonate ion concentration, and thus is kept at a sufficiently lower concentration than the saturation solubility. The concentration of gypsum in the concentrated water exceeds the saturation concentration, but the production of scales in the concentrated water is suppressed by the dispersed scale inhibitor.

In the first pH adjusting step, when the concentrated water in the first demineralizer 10 is adjusted to a pH at which the function of the scale inhibitor is reduced, gypsum is deposited in the crystallizing step. In view of the conditions under which calcium carbonate can be surely dissolved in FIGS. 2 and 3 and the scale inhibiting effect obtained from the results in FIGS. 4 and 5, the concentrated water of the first demineralizer 10 is adjusted to a pH of 6.0 or less, preferably 5.5 or less, more preferably 4.0 or less. Especially, when the concentrated water of the first demineralizer 10 is adjusted to a pH of 4.0 or less, the function of the scale inhibitor can be significantly reduced.

According to the kind of scale inhibitor, the pH lower limit in the second pH adjusting step and pH upper limit in the first pH adjusting step are appropriately set.

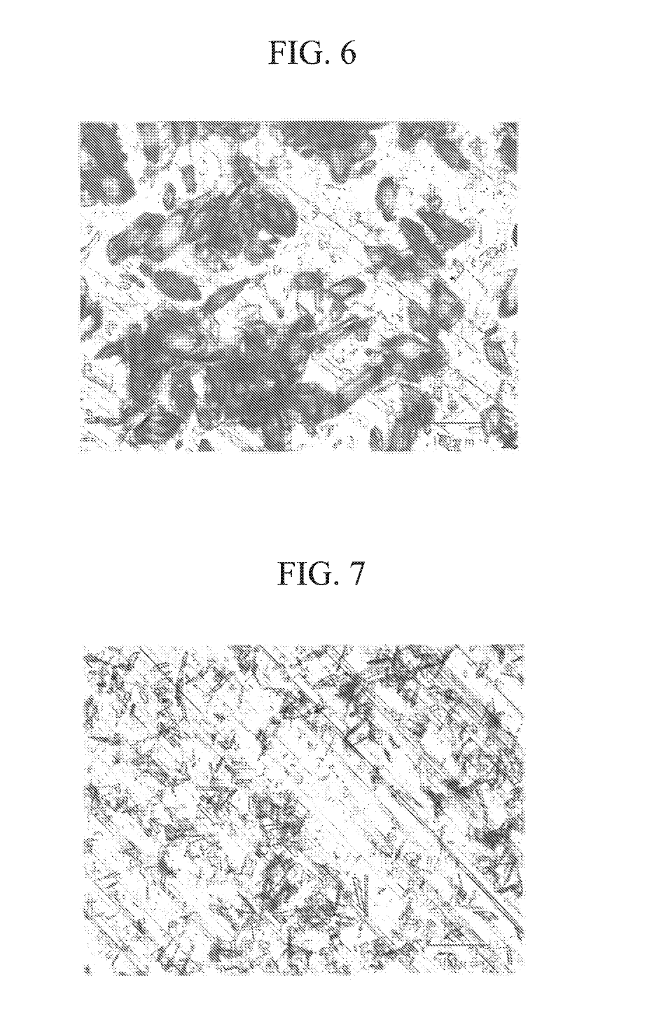

FIGS. 6 and 7 are microscopic photographs of gypsum obtained by crystallization. FIG. 6 shows results obtained under Condition 5 (seed crystals are added), and FIG. 7 shows results obtained under Condition 3 (no seed crystal is added). Under Condition 5, larger gypsum than that obtained under Condition 3 was deposited. In general, the larger the deposited gypsum is, the lower the water content is. If the average particle diameter is 10 μm or more, preferably 20 μm or more, gypsum having a sufficiently reduced water content is obtained. The “average particle diameter” in the present invention is a particle diameter measured by the method defined in JIS Z 8825 (laser diffraction method).

From the results in FIGS. 6 and 7, high-purity gypsum having a low water content can be deposited by adjusting the pH to a predetermined value in the first pH adjusting step and adding seed crystals in the crystallizing step. As the amount of added seed crystals becomes large (the seed crystal concentration within the crystallizing tank 13 becomes high), the gypsum deposition speed increases. The amount of added seed crystals is appropriately set based on the residence time within the crystallizing tank 13, scale inhibitor concentration and pH.

Since the water treatment system in FIG. 1 is an open system except the reverse osmosis membrane device, carbonate ions are dissolved in water when the water to be treated and concentrated water are brought into contact with air. However, the water to be treated and concentrated water are adjusted to a pH at which the solubility of calcium carbonate is high in the first and second pH adjusting steps, as described above. The carbonate ions in the concentrated water are reduced at the former stage of the crystallizing tank 13 or in the crystallizing tank 13 so that the solubility of calcium carbonate is the saturation solubility or less. Further, the environment established has a low carbonate ion concentration from balanced equation (1) since the pH is within a low region. Therefore, calcium carbonate is maintained at a sufficiently lower concentration than the saturation concentration within the crystallizing tank 13 so that no calcium carbonate is crystallized. Hence, the recovered gypsum contains almost no calcium carbonate.

Also, the solubility of salts containing a metal is high within an acidic region. Even through the pretreatment (precipitating section 71) or even when a metal remains in the water to be treated, no hydroxide containing a metal would be deposited in the crystallizing step if the pH of the concentrated water in the first demineralizer 10 is reduced in the first pH adjusting step in the above-described manner. When the water to be treated has the characteristic that it contains a large amount of Fe ions, almost no hydroxide containing Fe(OH)₃ in the crystallizing tank 13 is precipitated since the Fe concentration is reduced through the above-described pretreatment.

Thus, the water treatment process and water treatment system of this embodiment can be used to separate and recover high-purity gypsum hardly containing impurities including calcium carbonate and metal hydroxides.

When large gypsum having an average particle diameter of 10 μm or more, preferably 20 μm or more is crystallized, the crystallizing speed is generally reduced, and thus the residence time within the crystallizing tank 13 is prolonged. In this embodiment, a suitable crystallizing speed is ensured by adjusting the pH so that the function of the scale inhibitor is reduced and increasing the seed crystal concentration.

### <Recovering Step>

The concentrated water containing gypsum is discharged from the crystallizing tank 13, and delivered to the separating section 14. The classifier 15 separates the gypsum from the concentrated water in the first demineralizer discharged from the crystallizing tank 13. Gypsum having an average particle diameter of 10 μm or more is precipitated at the bottom part of the classifier 15, and gypsum having a small particle diameter remains in the supernatant. The gypsum precipitated at the bottom part of the classifier 15 is further dehydrated by the dehydrator 16 and recovered.

By the recovering step, gypsum having a low water content, containing no impurity and having high purity can be separated and recovered at a high recovery rate.

Since seed crystals are added for crystallization in this embodiment, gypsum having an average particle diameter of 10 μm or more is mainly deposited, and the proportion of gypsum having a small diameter is small.

When the classifier 15 is omitted as a modified example of this embodiment, the concentrated water in the crystallizing tank 13 is discharged from the bottom part. Crystallized large gypsum is precipitated in the concentrated water at the bottom part of the crystallizing tank 13. If the concentrated water mainly containing large gypsum is dehydrated by the dehydrator 16, high-purity gypsum can be recovered. Also, it is unnecessary to increase the volume of the dehydrator 16 because the water content of the gypsum is low.

### <Downstream Side Separating Step>

The concentrated water discharged from the separating section 14 is delivered to the precipitating section 81 and filtration device 82. In the steps similar to those of the precipitating section 71 and filtration device 72, gypsum and calcium carbonate remaining in the concentrated water after the separating step and the metal hydroxides remaining in the concentrated water are removed.

The concentrated water in the first demineralizer discharged from the filtration device 82 is delivered to the second demineralizer 12. Before the concentrated water flows into the second demineralizer 12, the scale inhibitor may be additionally added to the concentrated water in the first demineralizer.

The pH meter 70c measures the pH of the concentrated water in the first demineralizer at the inlet of the second demineralizer 12. The controlling section 52 of the third pH adjusting section 50 adjusts the opening degree of the valve V5 so that the measurement value at the pH meter 70c is a pH of 6.0 or less, preferably 5.5 or less, so that an acid is supplied to the concentrated water in the first demineralizer.

In the second demineralizer 12, the concentrated water from the first demineralizer is treated. Water having passed through the reverse osmosis membrane of the second demineralizer 12 is recovered as treated water. The concentrated water in the second demineralizer 12 is discharged to the outside of the system.

When the second demineralizer 12 is installed, the treated water can further be recovered from the water after crystallization of gypsum, so that the water recovery rate is improved.

The concentrated water from the first demineralizer 10 has a low ion concentration since gypsum has been removed by the treatment in the crystallizing section 11. Therefore, the second demineralizer 12 can reduce the osmotic pressure as compared with the case where no gypsum is removed, and thus the necessary motive power is reduced.

An evaporator (not shown in FIG. 1) may be installed at a downstream on a side of the concentrated water in the second demineralizer 12. Water is evaporated from the concentrated water in the evaporator so that ions contained in the concentrated water are deposited as solids and recovered as solids. Since water is recovered on an upstream side of the evaporator so that the amount of the concentrated water is significantly reduced, the evaporator can be reduced in size so that the energy necessary for evaporation can be decreased.

### Second Embodiment

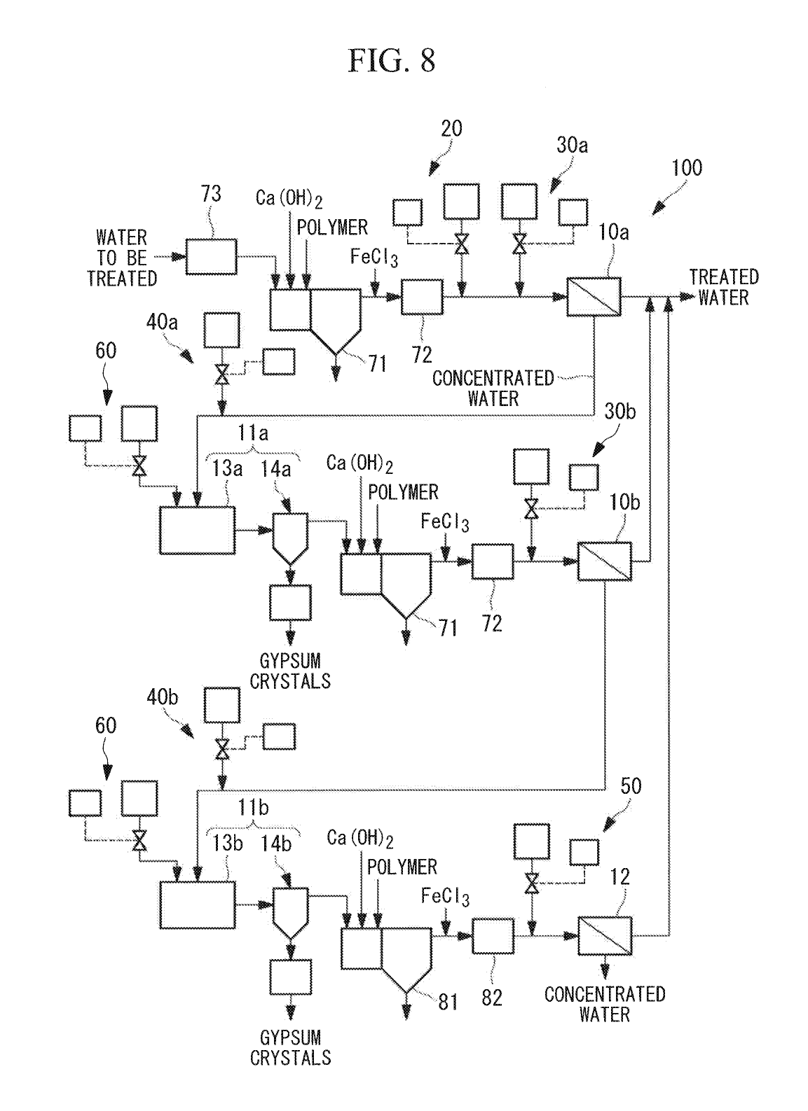

FIG. 8 shows a water treatment system of a second embodiment. The water treatment system 100 in FIG. 8 has such a construction that a plurality of first demineralizers (10a, 10b in FIG. 8) and crystallizing sections (11a, 11b in FIG. 8) are alternately arrayed in series in a direction in which water to be treated is distributed, and that a second demineralizer 12 is installed at a downstream of the most downstream crystallizing section 11b.

When a scale inhibitor is present in an effective amount at stages before the second demineralizer 12, a scale inhibitor supplying section 20 can be installed only in a flow passage on an upstream side of the first demineralizer 10a, as shown in FIG. 8. Alternatively, such a construction may be employed that scale inhibitor supplying sections are installed in flow passages near the upstream sides of the plurality of first demineralizers 10a, 10b to ensure an effective amount of scale inhibitor at stages before the second demineralizer 12.

Second pH adjusting sections 30a, 30b are installed in flow passages on upstream sides of the respective first demineralizers 10a, 10b. First pH adjusting sections 40a, 40b are installed in flow passages between the first demineralizers and the crystallizing sections.

Also in the second embodiment, the second pH adjusting sections can be omitted. As is the case with the first embodiment, such a construction may be employed that the classifier is omitted so that the bottom part of the crystallizing tank 13 and the dehydrator 16 are directly connected to each other.

In the meantime, pH meters, though not shown in FIG. 8, are installed at inlets of the first demineralizers 10a, 10b, crystallizing sections 11a, 11b and inlet of the second demineralizer 12.

A precipitating section 71b and filtration device 72b similar to those shown in FIG. 1 may be installed between the crystallizing section 11a and the first demineralizer 10b. Also, an evaporator and a crystallizer may be provided on a downstream side of the concentrated water in the second demineralizer 12.

When the plurality of first demineralizers 10a, 10b and crystallizing sections 11a, 11b are installed as shown in FIG. 8, ions in water flowing into the second demineralizer 12 are greatly reduced, so that the water recovery rate is improved. Also, the amount of gypsum recovered in the separating sections 14a, 14b increases. Further, the motive power of the second demineralizer 12 is greatly reduced.

### Third Embodiment

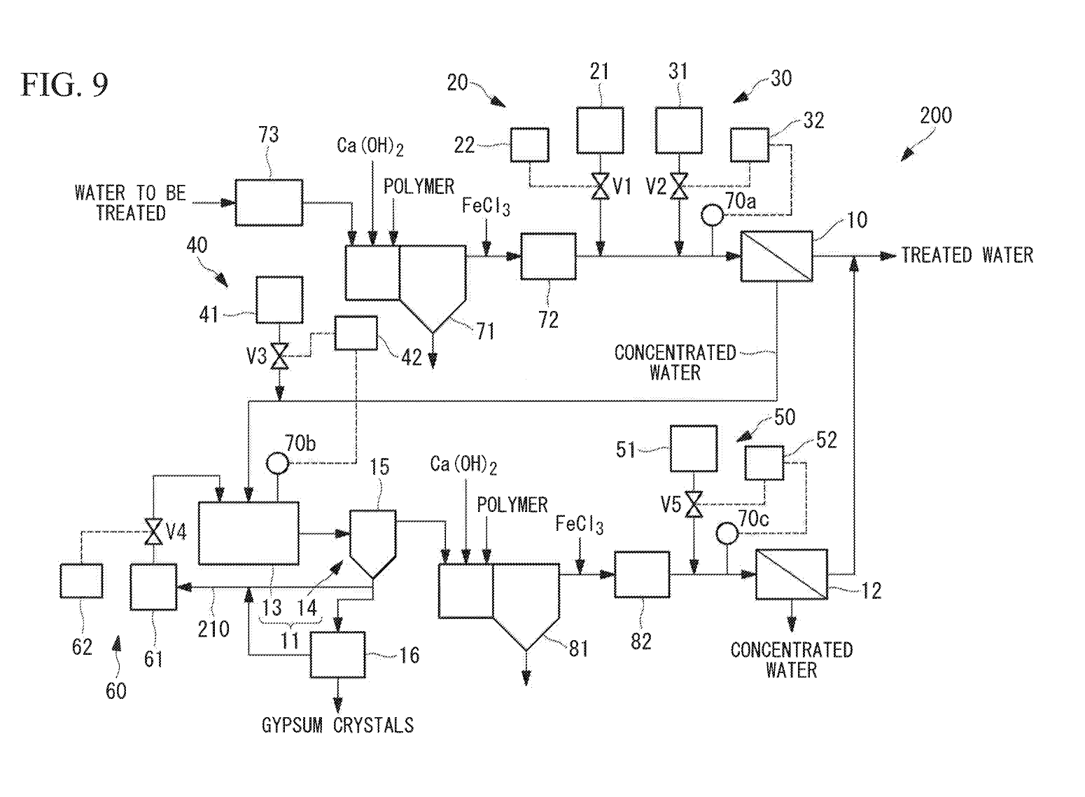

FIG. 9 is a schematic view of a water treatment system according to a third embodiment of the present invention. In FIG. 9, the same reference signs are attached to the same constructions as those in FIG. 1. The water treatment system 200 of the third embodiment is the same as that of the first embodiment except that it includes a seed crystal circulating section 210 which couples a classifier 15 and a dehydrator 16 with a tank 61 of a seed crystal supplying section 60. In this embodiment, the second pH adjusting section can be omitted.

The classifier 15 is used to separate gypsum having an average particle diameter of 10 μm or more, preferably 20 μm or more from concentrated water. Part of the gypsum recovered by the classifier 15 and dehydrator 16 in the separating section 14 is delivered to the seed crystal tank 61 via the seed crystal circulating section 210, and stored in the seed crystal tank 61. The recovered gypsum is supplied from the seed crystal tank 61 to the crystallizing tank 13.

In the seed crystal tank 61, acid treatment is subjected to the stored gypsum. When a scale inhibitor is attached to the gypsum separated in the separating section 14, the function of the scale inhibitor is reduced by the acid treatment. The kind of the acid used herein is not particularly limited, but sulfuric acid is optimum in consideration of the reduction in motive power in the second demineralizer 12.

While the gypsum crystallized in the crystallizing tank 13 has a broad particle diameter distribution, the gypsum having a particle diameter of 10 μm or more is separated and recovered from the concentrated water by using the classifier 15, and thus large gypsum can be utilized as seed crystals. When large seed crystals are charged, large gypsum can be crystallized in a large amount. That is, high-quality gypsum can be obtained at a high recovery rate. Also, large gypsum is easily separated by the classifier 15, thereby making it possible to reduce the size of the classifier 15 and also leading to the reduction in motive power. Large gypsum is easily dehydrated by the dehydrator 16, thereby making it possible to reduce the size of the dehydrator 16 and also leading to the reduction in motive power.

### REFERENCE SIGNS LIST

1, 100, 200 water treatment system
10, 10a, 10b first demineralizer
11, 11a, 11b crystallizing section
12 second demineralizer
13, 13a, 13b crystallizing tank
14, 14a, 14b separating section
15 classifier
16 dehydrator
20 scale inhibitor supplying section
30, 30a, 30b second pH adjusting section
40, 40a, 40b first pH adjusting section
50 third pH adjusting section
60, 60a, 60b seed crystal supplying section
70a, 70b, 70c pH meter
71, 71a, 71b, 81 precipitating section
72, 72a, 72b, 82 filtration device
73 oxidizing section
210 seed crystal circulating section

1. A water treatment process comprising:
a scale inhibitor supplying step of supplying a scale inhibitor to water to be treated containing Ca ions, SO₄ ions and carbonate ions;
an upstream side separating step of separating the water to be treated into concentrated water in which the Ca ions and the SO₄ ions are concentrated and treated water containing CO₂, in a first demineralizer, and recovering the treated water;
a first pH adjusting step of adjusting the concentrated water in the first demineralizer to a pH at which calcium carbonate is soluble and a scale inhibiting function of the scale inhibitor is reduced so that gypsum is deposited from the concentrated water in the first demineralizer;
a crystallizing step of crystallizing crystals of the gypsum from the concentrated water in the first demineralizer having the adjusted pH; and
a recovering step of separating and recovering the crystals from the concentrated water in the first demineralizer.

2. The water treatment process according to claim 1, further comprising a second pH adjusting step of adjusting the water to be treated to a pH at which the calcium carbonate is soluble and the scale inhibitor is capable of suppressing the deposition of a scale containing Ca, on an upstream side of the first demineralizer.

3. The water treatment process according to claim 1, wherein seed crystals of the gypsum are supplied to the concentrated water in the first demineralizer in the crystallizing step.

4. The water treatment process according to claim 3, wherein the separated and recovered gypsum is supplied, as the seed crystals, into the concentrated water in the first demineralizer in the crystallizing step.

5. The water treatment process according to claim 1, wherein gypsum having a predetermined size, in the gypsum deposited in the crystallizing step, is separated and recovered in the recovering step.

6. The water treatment process according to claim 1, comprising a downstream side separating step of separating the concentrated water in the first demineralizer after the crystallizing step into concentrated water and treated water in a second demineralizer, and recovering the treated water.

7. The water treatment process according to claim 6, wherein, on a downstream side of the concentrated water in the second demineralizer, water is evaporated from the concentrated water in the second demineralizer so that a solid is recovered.

8. (canceled)

9. (canceled)

10. (canceled)

11. (canceled)

12. (canceled)

13. (canceled)

14. (canceled)

15. The water treatment process according to claim 2, wherein seed crystals of the gypsum are supplied to the concentrated water in the first demineralizer in the crystallizing step.

16. The water treatment process according to claim 15, wherein the separated and recovered gypsum is supplied, as the seed crystals, into the concentrated water in the first demineralizer in the crystallizing step.

17. The water treatment process according to claim 2, wherein gypsum having a predetermined size, in the gypsum deposited in the crystallizing step, is separated and recovered in the recovering step.

18. The water treatment process according to claim 3, wherein gypsum having a predetermined size, in the gypsum deposited in the crystallizing step, is separated and recovered in the recovering step.

19. The water treatment process according to claim 4, wherein gypsum having a predetermined size, in the gypsum deposited in the crystallizing step, is separated and recovered in the recovering step.

20. The water treatment process according to claim 15, wherein gypsum having a predetermined size, in the gypsum deposited in the crystallizing step, is separated and recovered in the recovering step.

21. The water treatment process according to claim 16, wherein gypsum having a predetermined size, in the gypsum deposited in the crystallizing step, is separated and recovered in the recovering step.

22. The water treatment process according to claim 2, comprising a downstream side separating step of separating the concentrated water in the first demineralizer after the crystallizing step into concentrated water and treated water in a second demineralizer, and recovering the treated water.

23. The water treatment process according to claim 3, comprising a downstream side separating step of separating the concentrated water in the first demineralizer after the crystallizing step into concentrated water and treated water in a second demineralizer, and recovering the treated water.

24. The water treatment process according to claim 4, comprising a downstream side separating step of separating the concentrated water in the first demineralizer after the crystallizing step into concentrated water and treated water in a second demineralizer, and recovering the treated water.

25. The water treatment process according to claim 5, comprising a downstream side separating step of separating the concentrated water in the first demineralizer after the crystallizing step into concentrated water and treated water in a second demineralizer, and recovering the treated water.

26. The water treatment process according to claim 15, comprising a downstream side separating step of separating the concentrated water in the first demineralizer after the crystallizing step into concentrated water and treated water in a second demineralizer, and recovering the treated water.

27. The water treatment process according to claim 16, comprising a downstream side separating step of separating the concentrated water in the first demineralizer after the crystallizing step into concentrated water and treated water in a second demineralizer, and recovering the treated water.

28. The water treatment process according to claim 17, comprising a downstream side separating step of separating the concentrated water in the first demineralizer after the crystallizing step into concentrated water and treated water in a second demineralizer, and recovering the treated water.

29. The water treatment process according to claim 18, comprising a downstream side separating step of separating the concentrated water in the first demineralizer after the crystallizing step into concentrated water and treated water in a second demineralizer, and recovering the treated water.

30. The water treatment process according to claim 19, comprising a downstream side separating step of separating the concentrated water in the first demineralizer after the crystallizing step into concentrated water and treated water in a second demineralizer, and recovering the treated water.

31. The water treatment process according to claim 20, comprising a downstream side separating step of separating the concentrated water in the first demineralizer after the crystallizing step into concentrated water and treated water in a second demineralizer, and recovering the treated water.

32. The water treatment process according to claim 21, comprising a downstream side separating step of separating the concentrated water in the first demineralizer after the crystallizing step into concentrated water and treated water in a second demineralizer, and recovering the treated water.

33. The water treatment process according to claim 22, wherein, on a downstream side of the concentrated water in the second demineralizer, water is evaporated from the concentrated water in the second demineralizer so that a solid is recovered.

34. The water treatment process according to claim 23, wherein, on a downstream side of the concentrated water in the second demineralizer, water is evaporated from the concentrated water in the second demineralizer so that a solid is recovered.

35. The water treatment process according to claim 24, wherein, on a downstream side of the concentrated water in the second demineralizer, water is evaporated from the concentrated water in the second demineralizer so that a solid is recovered.

36. The water treatment process according to claim 25, wherein, on a downstream side of the concentrated water in the second demineralizer, water is evaporated from the concentrated water in the second demineralizer so that a solid is recovered.

37. The water treatment process according to claim 26, wherein, on a downstream side of the concentrated water in the second demineralizer, water is evaporated from the concentrated water in the second demineralizer so that a solid is recovered.

38. The water treatment process according to claim 27, wherein, on a downstream side of the concentrated water in the second demineralizer, water is evaporated from the concentrated water in the second demineralizer so that a solid is recovered.

39. The water treatment process according to claim 28, wherein, on a downstream side of the concentrated water in the second demineralizer, water is evaporated from the concentrated water in the second demineralizer so that a solid is recovered.

40. The water treatment process according to claim 29, wherein, on a downstream side of the concentrated water in the second demineralizer, water is evaporated from the concentrated water in the second demineralizer so that a solid is recovered.

41. The water treatment process according to claim 30, wherein, on a downstream side of the concentrated water in the second demineralizer, water is evaporated from the concentrated water in the second demineralizer so that a solid is recovered.

42. The water treatment process according to claim 31, wherein, on a downstream side of the concentrated water in the second demineralizer, water is evaporated from the concentrated water in the second demineralizer so that a solid is recovered.

43. The water treatment process according to claim 32, wherein, on a downstream side of the concentrated water in the second demineralizer, water is evaporated from the concentrated water in the second demineralizer so that a solid is recovered.
